(19) United States
(12) Patent Application Publication
(10) Pub. No.: US 2012/0329376 A1
(43) Pub. Date: Dec. 27, 2012

(54) FLUTTER SUPPRESSION AIRFLOW DISTRIBUTION DOOR

(76) Inventors: Zhengyu Liu, Novi, MI (US); Lawrence C. Karas, New Boston, MI (US); Curtis M. Jones, Wixom, MI (US)

(21) Appl. No.: 13/169,123

(22) Filed: Jun. 27, 2011

(51) Int. Cl. B60H 1/00; F24F 7/00

(52) U.S. Cl. 454/152; 454/330

(57) ABSTRACT

The present invention generally relates to an HVAC door and method of use for an HVAC system in a vehicle, and more specifically to an airflow distribution door for use in a vehicle climate control system configured to suppress flutter of the door.

### FIELD OF THE INVENTION

The present invention generally relates to an HVAC door for use in an HVAC system in a vehicle, and more specifically to an airflow distribution door for use in a vehicle climate control system configured to suppress flutter of the door in use.

### BACKGROUND OF THE INVENTION

HVAC door assemblies in vehicle climate control or HVAC systems provide air distribution functionality for the vehicle user. However, the varying pressures within a vehicle HVAC system can cause unsteady forces which lead to vortex shedding, door vibration or flutter, which ultimately leads to noise resonating throughout the HVAC system as well as less than peak performance of air distribution. HVAC systems are generally closed systems which will amplify noise which is created within the system. Vortex shedding is defined as an unsteady flow of air that is caused by air movement past a blunt or bluff object. The airflow past such an object will create alternating low pressure vortices and the object, such as an HVAC door, will tend to movement toward a zone of lower pressure, which causes the door to vibrate and flutter.

HVAC doors are a relatively large hinged-free type plate, and can be classified as two-dimensional bluff body in aerodynamics. In the airflow passages, it is a bluff structure which results into large vortex shedding or wakes generated by the door as airflows over the exposed sides of the door. This is especially true at high airflow and pressure conditions, and the vortex shedding/wakes can generate large unsteady forces, even locked-in flutters which have the potential to violently damage the bluff door structural integrity. For this reason, the vortex shedding effects have to be controlled to reduce the amplitude of the fluctuating lift as well as the drag on the door.

The present invention is designed to deliberately introduce airflow disruption such that unsteady forces in an HVAC system become less variable and resonant load frequencies on the HVAC door have negligible amplitudes.

### SUMMARY OF THE INVENTION

One aspect of the present invention includes an HVAC door assembly for a use in a vehicle's HVAC system wherein the door includes a first surface and a second surface. At least the first surface or the second surface, or both, include a planar portion and a non planar portion wherein the non planar portion includes undulations such that a cross section of the non-planar portion defines a sinusoidal wave pattern.

Another aspect of the present invention includes an HVAC door assembly for a vehicle climate control system wherein the door includes a first surface and a second surface. The first surface of the HVAC door has a planar frame portion with a seal disposed on the periphery of the planar frame portion. The seal is configured to seal the door to a housing in the vehicle climate control system. The door further comprises a non-planar portion on the first surface which includes a plurality of air flow disrupting projections extending outwardly from the planar portion which are configured to disrupt the flow of air over the door and thereby suppress door flutter.

Yet another aspect of the present invention includes a method of suppressing HVAC door flutter in a vehicle HVAC system which includes providing an HVAC door with a three-dimensional topographic surface capable of disrupting a moving airstream. The topographic surface then disrupts the airstream to provide a steady air force flow over the HVAC door. The steady flow of air reduces the vortex shedding, vibration, flutter, and noise in the HVAC system.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a cross-sectional view illustrating a vehicle climate control system;

FIG. 2 is a top plan view of an HVAC door in accordance with one embodiment of the invention;

FIG. 3 is a bottom perspective view of the HVAC door of FIG. 2;

FIG. 4 is a top perspective view of the HVAC door of FIG. 2;

FIG. 4A is a fragmented perspective view of the HVAC door of FIG. 4;

FIG. 5 is a cross-sectional view of the HVAC door of FIG. 2, taken along line X;

FIG. 6 is a top plan view of an HVAC door in accordance with another embodiment of the present invention;

FIG. 7 is a bottom perspective view of the HVAC door of FIG. 6;

FIG. 8 is a top perspective view of the HVAC door of FIG. 6;

FIG. 9 is a cross-sectional view of the HVAC door of FIG. 6, taken along line XI;

FIG. 10 is a top plan view of an HVAC door in accordance with another embodiment of the present invention;

FIG. 11 is a bottom perspective view of an HVAC door of FIG. 10;

FIG. 12 is a top perspective view of the HVAC door of FIG. 10;

FIG. 13 is a cross-sectional view of the HVAC door of FIG. 10, taken along line XII;

FIG. 14 is a top plan view of an HVAC door in accordance with yet another embodiment of the present invention;

FIG. 15 is a bottom perspective view of the HVAC door of FIG. 14;

FIG. 16 is a top perspective view of the HVAC door of FIG. 14; and

FIG. 17 is a cross-sectional view of the HVAC door of FIG. 14, taken along line XIII.

### DETAILED DESCRIPTION OF THE PREFERRED EMBODIMENT

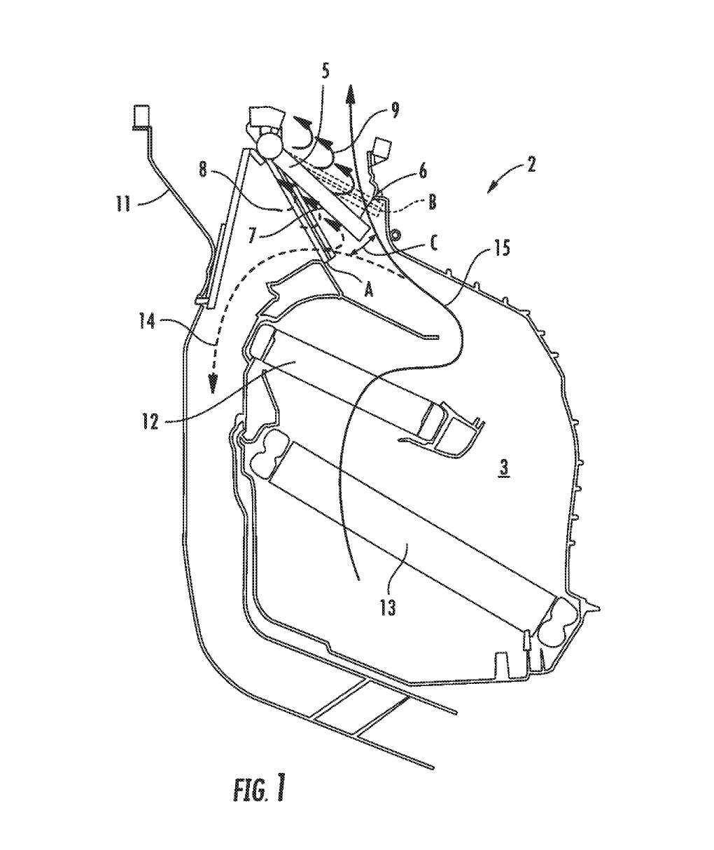

For the purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in following specification, are simply exemplary embodiments. Hence, specific dimensions and other physical characteristics relating to the embodiments disclosed herein are not to be construed as limiting, unless expressly stated otherwise.

Referring to FIG. 1, the reference numeral 2 generally designates a vehicle HVAC climate control unit or air conditioning/heating unit, which is generally disposed in the inner area of an instrument panel located in the front part of a vehicle compartment. The climate control unit 2 includes a casing 11 defining a series of airflow passages and chambers for directing air toward a vehicle compartment. The climate control unit further comprises a chamber 3 having a heat exchanger 12 and evaporator 13 disposed within the chamber 3. The heat exchanger 12 and evaporator 13 work to heat and cool the air, respectively, before the air is delivered to various locations within the vehicle compartment. The climate control unit 2 further comprises an HVAC door 5 which, in this embodiment, directs airflow between the vehicle panel and floor. The panel/floor HVAC door 5 is a relatively large hinged-free type plate, which means that the door 5 has two sides: one which is connected to an actuator, such as a DC motor, and therefore has a hinged or pinned boundary condition, and another side which is in a free condition for directing air to the vehicle's panel or floor. The HVAC door can be made from a variety of materials such as a molded ABS resin or other like polymeric substance which is injection molded, vacuum formed or otherwise configured. The HVAC door 5 further includes a first front surface 7 and a second rear surface 6 and the door 5 is movable between a position A and a position B, as the door moves along a path indicated by the arrow C. When the door 5 is in position A, airflow is directed to the vehicle panel, as indicated by air pathway 15. When the door 5 is in position A, air flowing along air pathway, indicated by solid arrow 15, flows over the rear surface 6 of door 5, causing reattaching sheer layers, indicated by arrows 9, that generate vortex shedding forces which cause flutter. When the door is in position B, airflow is directed toward the lower part of the vehicle compartment along an air pathway, indicated by broken line arrow 14, and air passes over the front surface 7 of door 5, causing reattaching sheer layers, indicated by arrows 8. These sheer layers can reattach to the HVAC door surface and cause the door to lift and flutter against the HVAC housing.

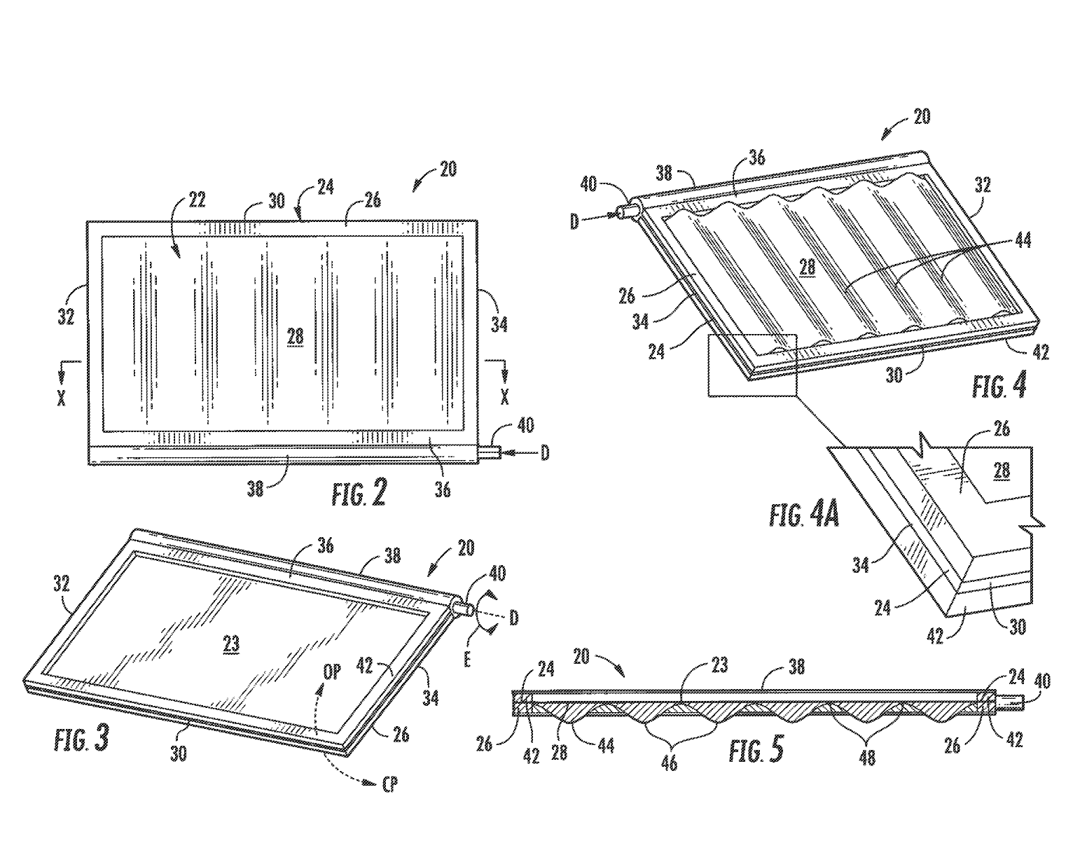

Referring to FIG. 2, an illustrated embodiment of an HVAC door assembly 20 is shown having an upper first surface 22, which includes a planar frame portion 24 having a seal 26 disposed thereon, and a non-planar body portion 28. The planar flame portion 24 comprises a front wall 30, side walls 32, 34, and a rear wall 36. Together, the front wall 30, side walls 32, 34, and rear wall 36 make up the planar frame portion 24 of the HVAC door 20 which surrounds non-planar body portion 28. In this embodiment, the seal 26 is disposed on the entirety of planar frame portion 24 to form an airtight seal between the door 20 and an HVAC door housing in assembly. The rear wall 36 has a pivot member 38 disposed thereon, wherein the pivot member 38 further comprises a pivot actuator member 40 which is used to connect the HVAC door 20 to a vehicle climate control actuator for moving the door 20 between various open and closed positions about pivot point D to direct airflow to different locations within the vehicle compartment. The seal 26 is made of a resilient material, such as sealing foam, padding or other like polymeric material, which is used to seal door 20 to a housing in the vehicle climate control system 2 (FIG. 1), such as a housing made up by the vehicle climate control casing 11.

FIG. 3 illustrates the lower surface 23 of the HVAC door 20. Lower surface 23 has a seal 42 disposed on the outer periphery of lower surface 23, and, in this embodiment, lower surface 23 is a planar surface. Seal 42 functions similarly to seal 26 in operation. As shown in FIG. 3, the HVAC door 20 pivots about pivot point D in a direction as indicated by arrow E between an open position (OP) and a closed position (CP). To prevent warping or twisting of the HVAC door, the lower surface or upper surface can include small ribs or a reinforcing wafer system to stiffen the door and increase the doors structural integrity.

As shown in FIG. 4, the upper surface 22 of the HVAC door 20 has a non-planar body portion 28 disposed within planar frame portion 24 which includes a plurality of undulations 44 disposed thereon. In this embodiment, the non-planar portion 28 comprises over 50% of the upper surface. The undulations 44 are shown, in this embodiment, as wave undulations spaced laterally apart spanwise across the non-planar body portion 28 of the HVAC door 20. The undulations 44 extend above the non-planar portion 24 of the HVAC door 20 to disrupt the airflow over the upper first surface 22 of the HVAC door 20, thereby suppressing HVAC door flutter as further described below.

FIG. 4A illustrates a zoomed-in view of the HVAC door 20, as shown in FIG. 4, which shows the planar frame portion 24 of the HVAC door 20 disposed between the upper seal 26 and lower seal 42 in configuration.

As shown in FIG. 5, the undulations 44 comprise projections 46 and recesses 48, such that from one projection to another projection, or from one recess to another recess, the cross-sectional view of the upper surface 22 of the HVAC door 20 defines a full sinusoidal wavelength. In the embodiment shown in FIG. 5, the non-planar portion 28 of upper surface 22 includes a uniform pattern of undulations 44 which are in the form of a sinusoidal wave pattern, wherein the projections 46 extend above the non-planar frame portion 24 of the upper surface 22 and the recesses 48 recess to the same plane as the planar frame portion 24.

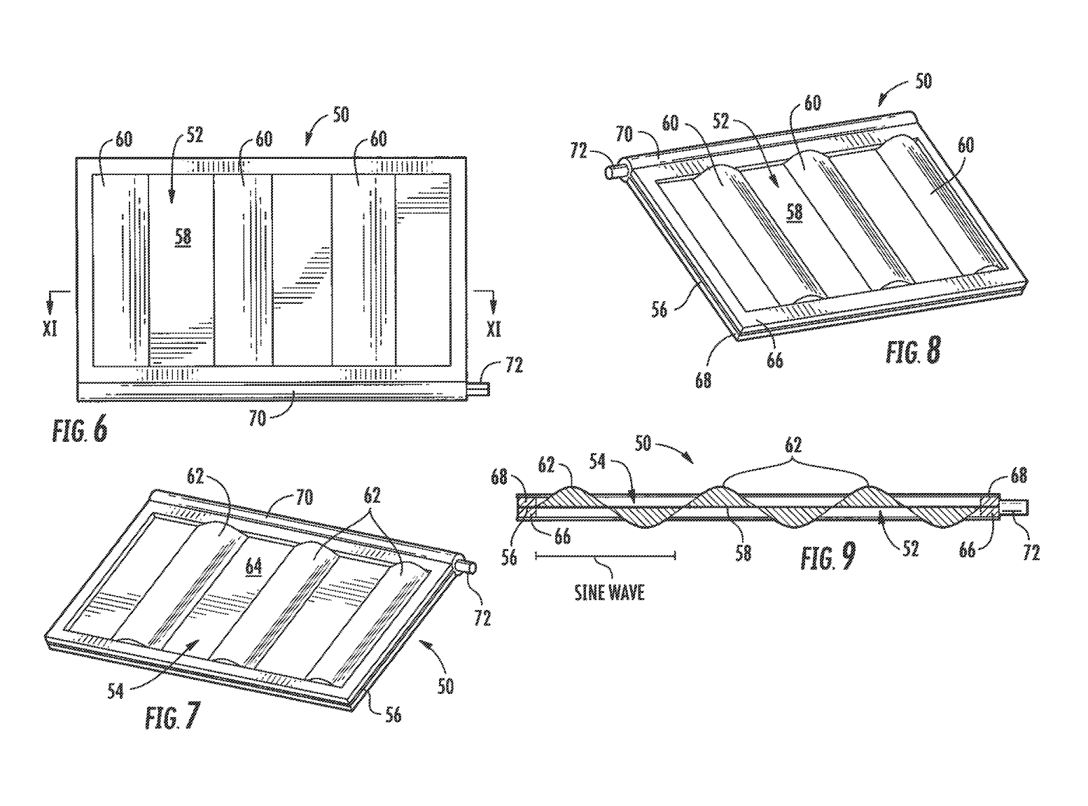

Referring now to FIGS. 6-9, the illustrated embodiment of the vehicle HVAC door assembly 50 includes an upper first surface 52 (FIG. 6) and a lower second surface 54 (FIG. 7). The HVAC door 50 comprises a planar frame portion 56 (FIGS. 7-9) disposed around the periphery of both the upper surface 52 and lower surface 54. The upper surface 52 further comprises a non-planar portion 58 disposed within the planar frame portion 56, wherein the non-planar portion 58 further comprises a plurality of airflow disrupting wave projections 60 extending outwardly from the plane of the planar frame portion 56. Lower surface 54 of the HVAC door 50 similarly comprises projections 62 disposed in a non-planar portion 64 of the lower surface 54, which are also capable of disrupting airflow passing over lower surface 54. Projections 60 and projections 62 are laterally disposed in a spaced-apart relationship on upper surface 52 and lower surface 54, respectively. Projections 60 and 62 are staggered in relation to each other on the upper and lower surfaces, such that, in the embodiment shown in FIGS. 6-9, the projections 60, 62 form a sine wave pattern between upper and lower surfaces 52, 54, as shown in the cross-sectional view of the HVAC door 50 in FIG. 9. The HVAC door 50 of FIGS. 6-9 has an upper seal 66 and a lower seal 68 disposed in either side of planar frame portion 56, as well as a pivot member 70 having a pivot actuator flange 72 similar to the embodiment shown in FIGS. 2-5.

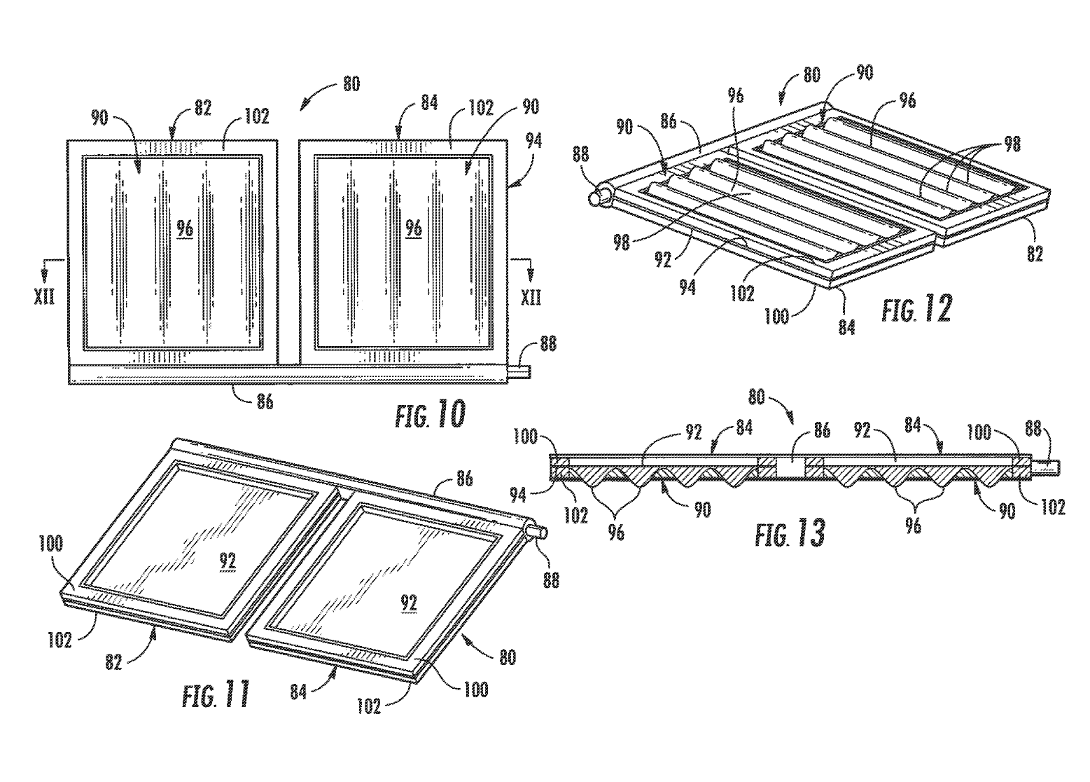

Referring now to FIGS. 10-13, the illustrated embodiment of the vehicle climate control HVAC door assembly 80 includes a first door 82 and a second door 84. Doors 82, 84 share a common pivot member 86 having a pivot actuator flange 88. In the embodiment shown in FIGS. 10-13, the first and second doors 82, 84 of HVAC door 80 comprise upper sides 90 and lower sides 92. The upper sides 90 comprise planar frame portions 94 and non-planar body portions 96. The non-planar body portions 96 further comprise a plurality of projections 98 which are capable of disrupting airflow as air passes over upper surface 90 of the HVAC door 80. As shown in FIG. 13, the projections 98 form a sinusoidal wave pattern when upper surface 90 is viewed in cross section. As shown in FIG. 11, lower surface 92 is planar and has a seal 100 disposed around its periphery. Similarly, the upper surface 90 of first and second doors 82, 84 has a seal 102 disposed on planar frame portion 94. This double door design of the embodiment shown in FIGS. 10-13 is designed to open and close two air pathways in a vehicle HVAC system. In assembly, the HVAC door 80 of this embodiment would be used in a vehicle HVAC system wherein a housing formed with side-by-side air pathways would correlate to the configuration of the HVAC door 80, such that the seals 100 and 102 disposed on the upper surface 90 and lower surfaces 82 would align with the housing of the vehicle HVAC system to seal the dual HVAC system air pathways.

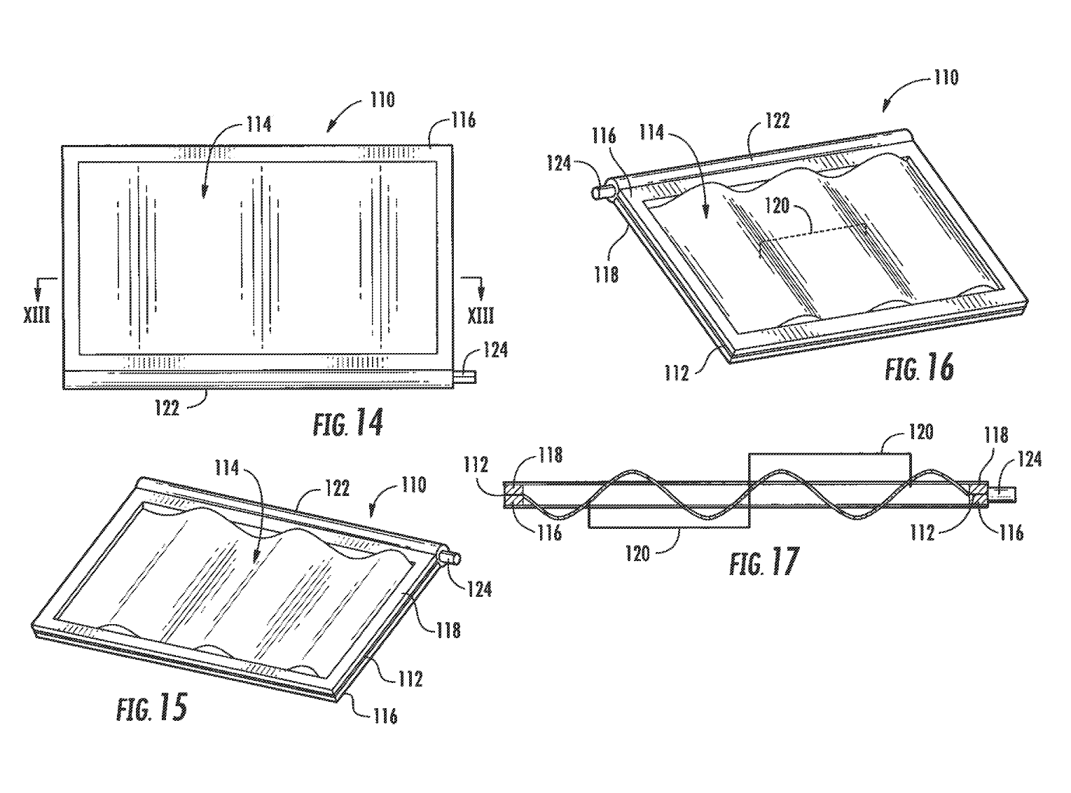

Referring now to FIGS. 14-17, the illustrated embodiment of the HVAC door assembly 110 includes a planar frame portion 112 disposed around the periphery of the HVAC door 110 and a web portion 114 disposed within the planar frame portion 112. The planar frame portion 112 has seals 116 and 118 disposed on either side of the planar frame portion 112 for use in sealing the HVAC door 110 to a housing in a vehicle climate control system. The web portion 114 includes sinusoidal wave form undulations 120 which give the cross section of the web portion 114 a sinusoidal wave pattern form (FIG. 17). The embodiment shown in FIGS. 14-17 further comprises a pivot member 122 and a pivot member actuator flange 124 similar to the pivot members and pivot actuator flanges described above for selectively moving the door 110 to varying positions to direct airflow.

The embodiments disclosed herein include spanwise undulations of varying wave steepness. The wave steepness of the non-planar portions of the embodiments disclosed herein is a factor which is variable, depending on the airflow of the specific HVAC system in question. The wave steepness disrupts the airflow and reduces or suppresses vortices which cause HVAC door flutter in an HVAC system. Generally, an HVAC door is classified as a two-dimensional bluff body, such that it exhibits significant drag and strong vortex shedding in a high airflow field. Drag is the aerodynamic force resisting the motion of the object through the air that is produced by front and rear pressure differences and sharing between the fluid and solid surface. A vortex shedding frequency coincides with a door structural resonance, then “locked in” violent vibration can be induced, which can compromise the HVAC door structural integrity. The undulations, as found in the embodiments disclosed herein, breaks up the pressure differential, such that a constant and steady air force is distributed over the HVAC door surfaces, and door flutter is, thereby, suppressed. When the vortex shedding effects are controlled by undulated wave patterns in the HVAC door, the amplitude of the fluctuating lift, as well as the drag forces on the HVAC door are reduced, such that noise and vibration can be suppressed in the HVAC system. While the embodiments shown herein include sinusoidal wave patterns, it is contemplated that persons of skill in the art will appreciate that other three dimensional geometric figures will also cause the disturbance in airflow needed to weaken the vortex shedding features.

It is to be understood that variations and modifications can be made on the aforementioned structure without departing from the concepts of the present invention, and further it is to be understood that such concepts are intended to be covered by the following claims unless these claims by their language expressly state otherwise.

What is claimed:

1. An HVAC door assembly comprising:
a first surface and a second surface, wherein at least one of the first surface and second surface includes a planar portion and a non-planar portion, wherein the non-planar portion includes undulations such that a cross section of the non-planar portion defines a sinusoidal wave pattern.

2. An HVAC door assembly as set forth in claim 1, wherein:
the first surface includes a planar portion having a seal disposed thereon.

3. An HVAC door assembly as set forth in claim 2,, wherein:
the second surface comprises a planar portion having a seal disposed thereon.

4. An HVAC door assembly as set forth in claim 3, wherein:
the first surface includes a non-planar portion having undulations such that a cross section of the first surface defines a sinusoidal wave pattern wherein the wave pattern has a wave steepness such that the undulations extend outwardly from the planar portion to disrupt an airflow over the door.

5. An HVAC door assembly as set forth in claim 4, wherein:
the undulations extend outwardly beyond the seal disposed on the planar portion.

6. An HVAC door assembly as set forth in claim 4, wherein:
the second surface includes a non-planar portion having undulations such that a cross section of the second surface defines a sinusoidal wave pattern wherein the wave pattern has a wave steepness such that the undulations extend outwardly from the planar portion to disrupt an airflow over the door.

7. An HVAC door assembly as set forth in claim 6, wherein:
the undulations of the second surface extend outwardly beyond the seal disposed on the planar portion.

8. An HVAC door assembly as set forth in claim 3, wherein:
the undulations are disposed in a spaced apart relationship along the first surface and second surface and transversely across a web defined by the first and second surfaces, the undulations on the first surface being staggered in relationship with respect to the undulations on the second surface such that a cross section of the web defines a sine wave form.

9. An HVAC door assembly as set forth in claim 3, wherein:
the door further comprises a pivot member disposed on the planar frame portion.

10. An HVAC door assembly as set forth in claim 9, wherein:
the pivot member further comprises a pivot actuator member disposed on the pivot member.

11. An HVAC door assembly for a vehicle climate control system comprising:
a first surface and a second surface;
the first surface having a planar frame portion with a seal disposed thereon for sealing the door to a housing, and a non-planar portion comprising a plurality of air flow disrupting projections extending outwardly from the planar portion.

12. An HVAC door assembly as set forth in claim 11, wherein:
the non-planar portion comprises over 50% of the first surface.

13. An HVAC door assembly as set forth in claim 12, wherein:
the plurality of air flow disrupting projections define a sinusoidal wave pattern when the first surface is viewed in cross section.

14. An HVAC door assembly as set forth in claim 13, wherein:
a pivot member is disposed on the planar frame portion which further comprises a pivot actuator member disposed thereon.

15. A vehicle HVAC door assembly comprising:
a planar frame portion and a non-planar portion disposed within the planar frame portion wherein the non-planar portion includes undulations such that a cross section of the vehicle HVAC door defines a sinusoidal wave pattern.

16. A vehicle HVAC door assembly as set forth in claim 15, wherein:
the planar frame portion has a seal disposed on a periphery of the planar frame portion.

17. A vehicle HVAC door assembly as set forth in claim 16, wherein:
the undulations extend vertically above the seal to disrupt an airflow over the door.

18. A vehicle HVAC door assembly as set forth in claim 15, wherein:
the sinusoidal wave pattern includes a plurality of sinusoidal waves.

19. A vehicle HVAC door assembly as set forth in claim 15, wherein:
the door further comprises a pivot member disposed on the planar frame portion.
